(19) United States
(12) Patent Application Publication
(10) Pub. No.: US 2018/0293544 A1
(43) Pub. Date: Oct. 11, 2018

(54) SYSTEMS AND METHODS FOR ARRANGING TRANSPORTATION FOR PEOPLE AND/OR CARGO

(71) Applicant: Wajdi Zein El Dean, Edison, NJ (US)

(72) Inventor: Wajdi Zein El Dean, Edison, NJ (US)

(21) Appl. No.: 15/949,029

(22) Filed: Apr. 9, 2018

Related U.S. Application Data
(60) Provisional application No. 62/484,021, filed on Apr. 11, 2017.

(51) Int. Cl. G06Q 10/08; G06Q 30/06

(52) U.S. Cl. CPC G06Q 10/08345; G06Q 30/0645

(57) ABSTRACT

A system is provided for transporting a person or cargo by authenticating a service provider's ability to provide the transportation service at a predetermined price. The system comprises a client device for generating transportation service requests as requested by a user. The client device selects the service provider and executes an agreement with the service provider. The system also comprises a service provider device for generating service provider data, for viewing pricing, for accepting service requests, and for executing the agreement. The system also comprises a transportation arrangement system device for receiving the service requests and the service provider data, authenticating the service provider data, executing filtering schemes to create sub-sets of service providers capable of providing service requests. The transportation arrangement system device also determines prices for service requests, receives acceptance of service requests, facilitates selection of service providers and facilitates agreements between service providers and client device users.

### COPYRIGHT NOTICE

A portion of the disclosure of this patent document contains material which is or may be subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### CROSS-REFERENCE TO RELATED APPLICATIONS

This application claims the benefit of the U.S. provisional patent application entitled “Systems and Methods for Arranging Transportation for Cargo”, having Ser. No. 62/484,021, filed Apr. 11, 2017, which is hereby incorporated by reference in its entirety as if fully set forth herein.

### BACKGROUND OF THE INVENTION

Customers seeking transportation services for passengers or cargo seek the most convenient availability at the lowest price. They also seek safety for passengers as well as reliability of delivery of goods. Customers also desire vehicles they rent to be in good working order and available in form factors that suit their needs. Service providers that rent vans and trucks, with and without drivers, seek a steady stream of profitable business from customers that pay as agreed and return rented vehicles in the agreed condition.

### BRIEF SUMMARY OF THE INVENTION

In an embodiment, a transportation arrangement system for transporting a person or cargo by authenticating a service provider's ability to provide the transportation service at a predetermined price is provided. The system comprises at least one client user computing device adapted for generating transportation service requests for individual user accounts as requested by a respective user, for selecting the service provider, and for executing an agreement with the service provider. The system also comprises at least one client service provider computing device generating service provider data for individual service provider user accounts associated with a respective service provider, for viewing pricing in correlation with available transportation service requests, for accepting available transportation service requests, and for executing an agreement with the user. The system also comprise at least one transportation arrangement system computing device adapted for receiving the transportation service requests and the service provider data, for authenticating the service provider data, and for executing at least one filtering scheme to create a sub-set of service providers capable of providing each of the transportation service requests. The at least one transportation arrangement system computing device is also adapted for determining a price to be charged for the transportation service requests, advertising the price for the transportation service requests in correlation with the transportation service request to the respective sub-set of service providers, and receiving acceptance of available transportation service requests from one or more of the sub-set of service providers. The at least one transportation arrangement system computing device is also adapted for facilitating selection of one of the sub-set of service providers and facilitating a written agreement between the user and the selected one of the sub-set of service providers.

In an embodiment, a transportation service method for transporting a person or cargo by authenticating a service provider's ability to provide the transportation service at a predetermined price is provided. The method comprises an at least one client user computing device generating a transportation service request. The method also comprises the at least one client user computing device selecting a service provider to fulfil the service request. The method also comprises the at least one client user computing device generating an agreement with the service provider describing the service request. The method also comprises an at least one client service provider computing device generating service provider data for the selected service provider. The method also comprises the at least one client service provider computing device accepting the transportation service request. The method also comprises the at least one client service provider computing device executing the agreement with a user of at least one client user computing device. The method also comprises an at least one transportation arrangement system computing device receiving the transportation service request and the service provider data. The method also comprises the at least one transportation arrangement system computing device authenticating the service provider data and facilitating the agreement between the user and the service provider.

In an embodiment, a transportation arrangement system for transporting a person or cargo is provided. The system comprises a processor, a memory, and an application stored in the memory that when executed on the processor receives transportation service requests and service provider data for candidate service providers to service the requests. The system also authenticates the service provider data. The system also executes at least one filtering scheme to create a sub-set of service providers capable of providing each of the transportation service requests. The system also determines prices to be charged for the transportation service requests. The system also receives acceptance of the transportation service requests from at least one of the sub-set of service providers.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 depicts a schematic view of an exemplary network environment in accordance with an embodiment of the present disclosure;

FIG. 2 depicts a block diagram of an exemplary computing device in accordance with an embodiment of the present disclosure;

FIG. 3 is a block diagram of a system for arranging transportation for people and/or cargo in accordance with an embodiment of the present disclosure;

FIGS. 4A and 4B depict a flowchart of a method for a user to arrange transportation for people and/or cargo in accordance with an embodiment of the present disclosure;

FIGS. 5A and 5B depict a flowchart of a method for a driver to arrange transportation for people and/or cargo in accordance with an embodiment of the present disclosure;

FIG. 6 depicts an exemplary data input screen for a user who wishes to transport people and/or cargo in accordance with one embodiment of the present invention;

FIG. 7 depicts an exemplary service request information screen provided to a service provider in accordance with one embodiment of the present invention; and

FIG. 8 depicts an exemplary data input screen for a user who wishes to rent a vehicle in accordance with one embodiment of the present invention.

The subject application references certain processes which are presented as series of ordered steps. It should be understood that the steps described with respect to those processes are not to be understood as enumerated consecutive lists but could be performed in various orders while still embodying the invention described herein.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a vehicle” may include a plurality of vehicles. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

Various embodiments of the present invention provide methods, executable by an application or program resident on a computing device and/or in a computing system environment, to arrange transportation for people and/or cargo. The application generally prompts a user to select a desired transportation route, after which various databases are searched for an available mode of transportation. The user is then presented with options to identify one or more modes of transportation for which the user would like pricing. The application also provides the user with the ability to manually change any of the selected and/or auto generated characteristics of the modes of transportation.

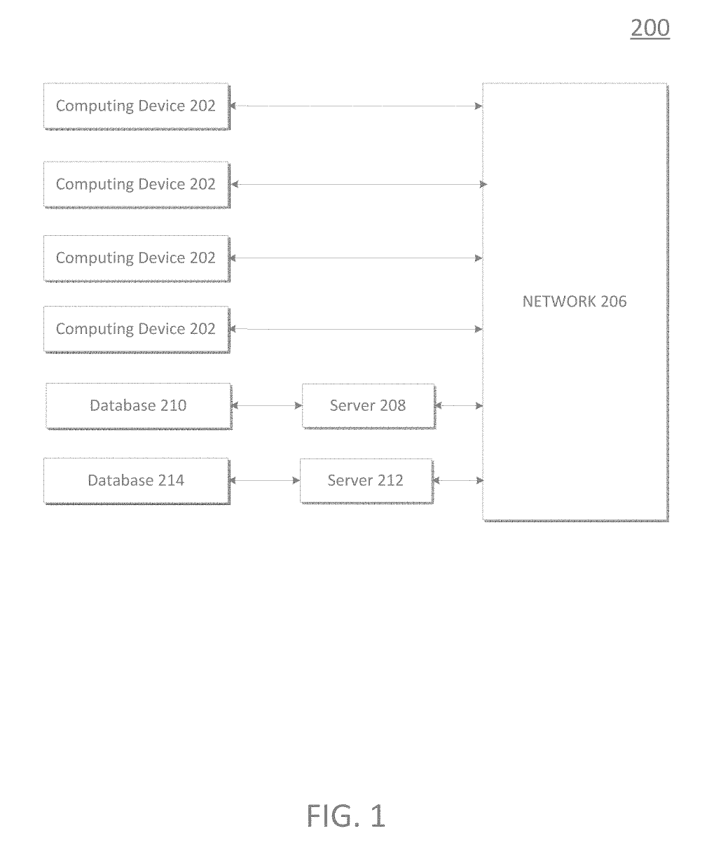

Referring now to FIG. 1, depicted is an exemplary computing system environment for allowing a user of system 200 to perform the methods described herein. The depicted computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, tablets, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types.

Distributed computing environments may be used where tasks are performed by remote processing devices that are linked through a communications network or other data transmission medium. In a distributed computing environment, program modules and other data may be located in both local and remote computer storage media including memory storage devices.

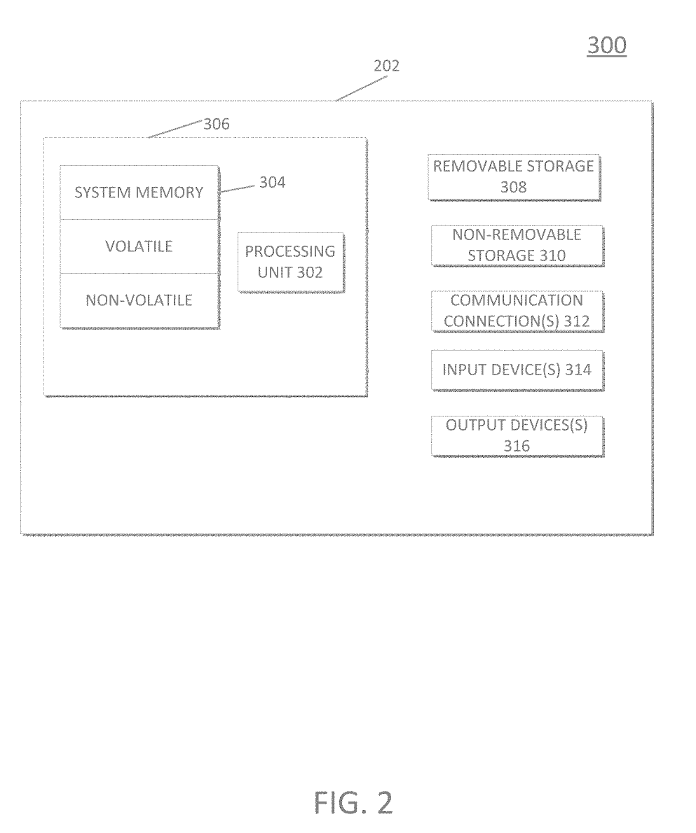

In the depicted embodiment, exemplary system 200 includes, inter alia, one or more computing devices 202 and one or more servers 208, 212 with corresponding databases, such as database 210 and database 214. The servers and databases shown in FIG. 2 are merely exemplary and servers and/or databases may be omitted or added without departing from the scope of the present invention. Further, databases 210, 214 may be combined into a single database and/or may be included in the respective servers without departing from the scope hereof. It should also be appreciated that one or more databases, including databases 210, 214 may be combined, provided in or distributed across one or more of computing devices 202, dispensing with the need for servers 208, 212 altogether.

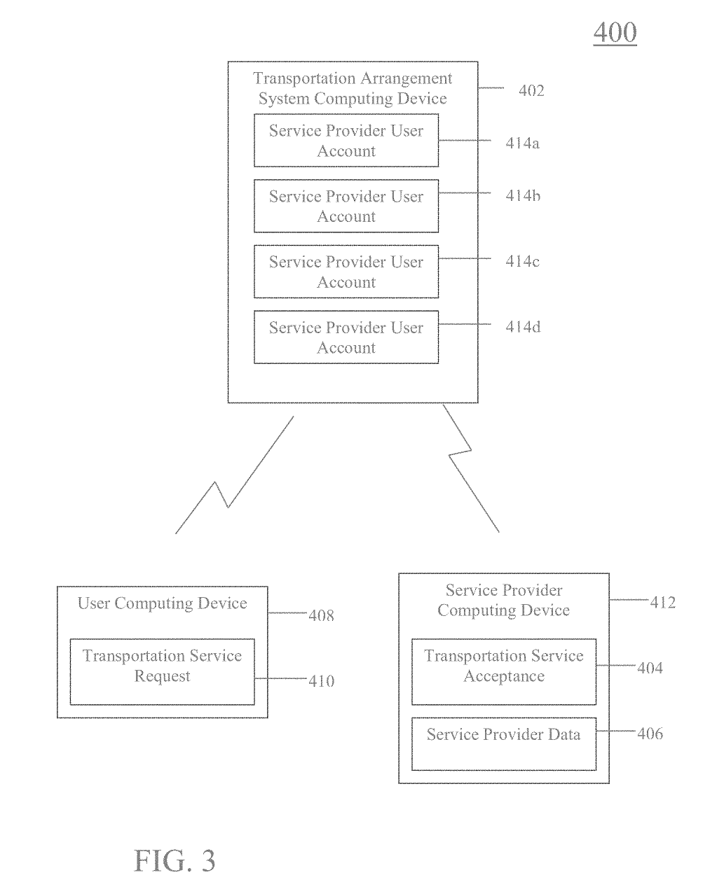

In its most basic configuration, as depicted in FIG. 2, computing device 202 includes at least one processing unit 302 and at least one memory 304. Depending on the exact configuration and type of the computing device, memory 304 may be volatile (such as random-access memory (“RAM”)), non-volatile (such as read-only memory (“ROM”), flash memory, etc.), or some combination of the two. This most basic configuration is illustrated in FIG. 3 by dashed lines 306. In addition to that described herein, computing devices 202 can be any web-enabled handheld device (e.g., cell phone, smart phone, or the like) or personal computer including those operating via Android™, Apple®, and/or Windows® mobile or non-mobile operating systems.

Computing device 202 may have additional features/functionality. For example, computing device 202 may include additional storage (removable and/or non-removable) including, but not limited to, magnetic or optical disks or tape, thumb drives, and external hard drives as applicable. Such additional storage is illustrated in FIG. 2 by removable storage 308 and non-removable storage 310.

Computing device 202 typically includes or is provided with a variety of computer-readable media. Computer-readable media can be any available media that can be accessed by computing device 202 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 304, removable storage 308, and non-removable storage 310 are all examples of computer storage media. Computer storage media includes, but is not limited to, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, or any other medium which can be used to store the desired information and which can accessed by computing device 202. Any such computer storage media may be part of computing device 202 as applicable.

Computing device 202 may also contain communications connection 312 that allows the device to communicate with other devices. Such communications connection 312 is an example of communication media. Communication media typically embodies computer-readable instructions, data structures, program modules and/or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (“RF”), infrared and other wireless media. The term computer-readable media as used herein includes both storage media and communication media.

Computing device 202 may also have input device(s) 314 such as keyboard, mouse, pen, voice input device, touch input device, etc. for receiving input from a user. Output device(s) 316 such as a display, speakers, printer. etc. may also be included. All these devices are generally known to the relevant public and therefore need not be discussed in any detail herein except as provided.

Notably, referring back to FIG. 1, computing device 202 may be one of a plurality of computing devices 202 inter-connected by network 206. As may be appreciated, network 206 may be any appropriate network and each computing device 202 may be connected thereto by way of connection 312 in any appropriate manner, and each computing device 202 may communicate with one or more of the other computing devices 202 via network 206 in any appropriate manner. For example, network 206 may be a wired network, wireless network, or a combination thereof within an organization or home or the like, and may include a direct or indirect coupling to an external network such as the Internet or the like. Likewise, network 206 may be such an external network including, without limitation, the Internet. In the exemplary embodiments shown herein, network 206 is the Internet and allows the multiple systems necessary to implement the systems and methods discussed herein to communicate data quickly and efficiently. However, alternate networks and/or methods of communicating information may be substituted without departing from the scope hereof.

Computing device 202 may connect to the various servers via such an internal or external network. Although FIG. 1 depicts computing device 202 located in close proximity to servers 208, 212, this depiction is not intended to define any geographic boundaries. For example, when network 206 is the Internet, computing device can have any physical location. For example, computing device may be a tablet, cell phone, personal computer, or the like located at any user's office, home, etc. Or computing device could be located proximate to one or more servers without departing from the scope hereof. Also, although FIG. 2 depicts computing devices 202 coupled to servers 208, 212 via network 206, computing devices may be coupled directly to one or more servers via any other compatible networks including, without limitation, an intranet, local area network, or the like.

The depicted embodiment of system 200 may use a standard client server technology architecture, which allows users of system 200 to access information stored in the databases via custom user interfaces. In some embodiments of the present invention, the processes are hosted on one or more servers which are accessible via the Internet using a publicly addressable Uniform Resource Locator (“URL”). For example, users can access exemplary system 200 using any web-enabled device equipped with a web browser. Communication between software component and sub-systems are achieved by a combination of direct function calls, publish and subscribe mechanisms, stored procedures, and direct SQL queries, however, alternate components, methods, and/or sub-systems may be substituted without departing from the scope hereof. Also, alternate embodiments are envisioned in which a computing device 202 directly accesses one or more servers through a private network rather than via the Internet and a URL.

Computing devices 202 may be equipped with one or more Web browsers to allow them to interact with one or more servers and/or databases via a Hypertext Transfer Protocol (“HTTP”). HTTP functions as a request-response protocol in client-server computing. For example, a web browser operating on computing device 202 may execute a client application that allows it to interact with applications executed by the one or more servers. The client application submits HTTP request messages to the one or more servers. The corresponding servers, which provide resources such as HTML files and other data or content, or performs other functions on behalf of the client application, returns a response message to the client application upon request. The response typically contains completion status information about the request as well as the requested content. However, alternate methods of computing device/server communications may be substituted without departing from the scope hereof including those that do not utilize the Internet for communications.

In the exemplary system 200, the databases may include a plurality of databases and/or database tables. As may be appreciated, the databases may be any appropriate database capable of storing data and may be included within or connected to one or more servers similar to those described herein in any appropriate manner without departing from the scope hereof.

It should be understood that the various techniques described herein may be implemented in connection with hardware or software or, as appropriate, with a combination of both. Thus, the methods and apparatus of the presently disclosed subject matter, or certain aspects or portions thereof, may take the form of program code (i.e., instructions, scripts, and the like) embodied in tangible media, such as floppy diskettes. CD-ROMs, hard drives, flash drives, DVDs or any other machine-readable storage medium wherein, when the program code is loaded into and executed by a machine, such as a computer, the machine becomes an apparatus for practicing the presently disclosed subject matter.

In the case of program code execution on programmable computers, the interface unit generally includes a processor, a storage medium readable by the processor (including volatile and non-volatile memory and/or storage elements), at least one input device, and at least one output device. One or more programs may implement or utilize the processes described in connection with the presently disclosed subject matter (e.g., through the use of an application-program interface (“API”), reusable controls, or the like). Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as system 200 or a distributed computing environment. Still further, aspects of the presently disclosed subject matter may be implemented in or across a plurality of processing chips or devices, and storage may similarly be affected across a plurality of devices in system 200. Such devices might include personal computers, network servers, and handheld devices (e.g., cell phones, tablets, smartphones, etc.), for example.

Disclosed herein are systems and methods for arranging transportation for people and/or cargo. These systems and methods may include, but are not limited to, transportation of passengers and goods both intrastate and interstate as well vehicle rental for use both intrastate and interstate. In embodiments, vehicles with or without drivers may be rented for use with the cost of such drivers, if any, included in the rental price. When a customer or user is renting a large vehicle, for example a truck, wherein a special license is required to operate said vehicle, the customer is required to produce such license for inspection and verification prior to taking delivery of the vehicle.

Turning now to FIG. 3, depicted is a block diagram of a system for arranging transportation for people and/or cargo in accordance with an embodiment of the present disclosure. FIG. 3 depicts components and interactions of a transportation arrangement system or system 400. Computing devices 402, 408, and 412 are as depicted and described above in connection with FIG. 1 and FIG. 2 and computing device 202 and/or computing environment 200.

The system 400 comprises transportation arrangement system computing device 402, a transportation service request 404 and service provider data 406. The system 400 also comprises user computing device 408 and a transportation service request 410. The system 400 also comprises a service provider computing device 412 and service provider user accounts 414a, 414b. 414c, 414d. These computing devices may communicate with each other via a network such as the exemplary network 200 described hereinabove.

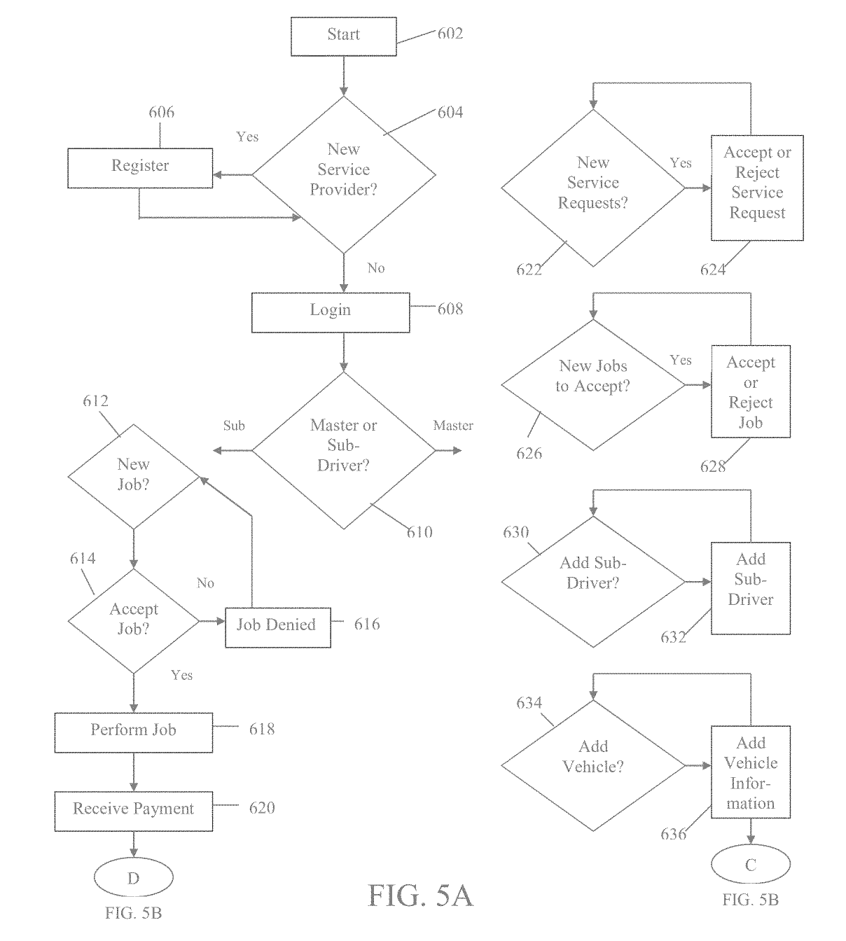

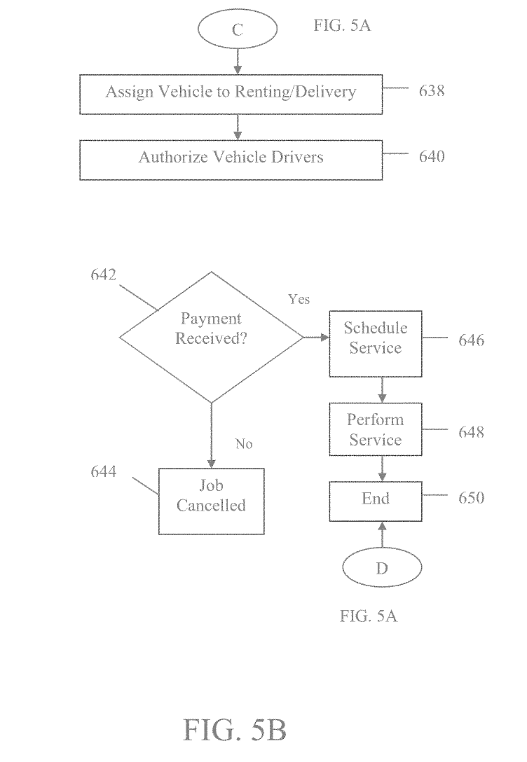

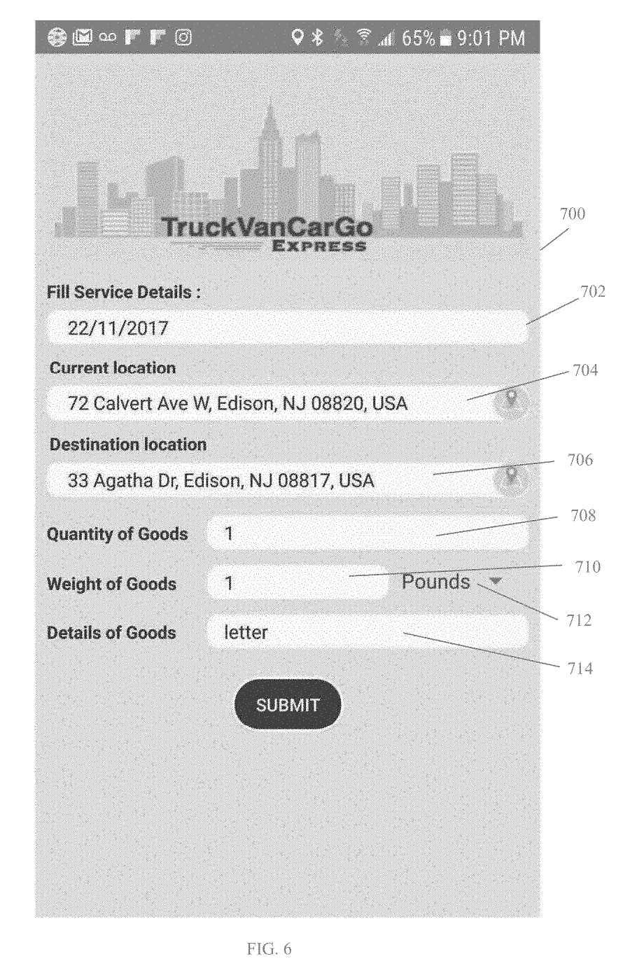

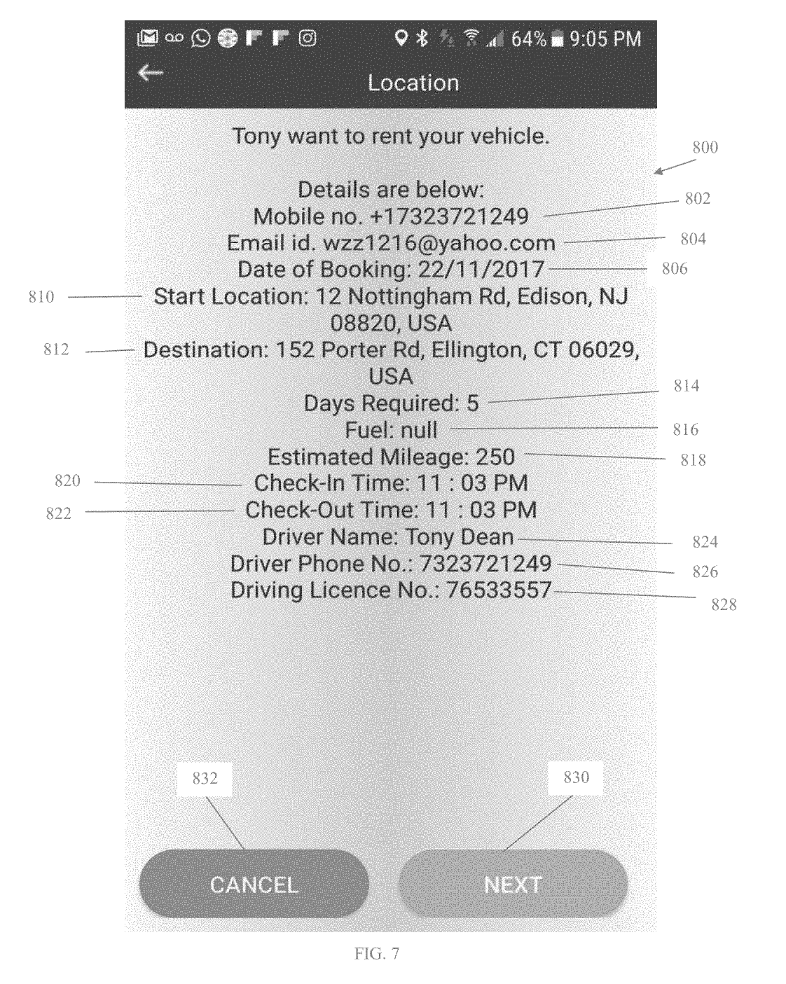

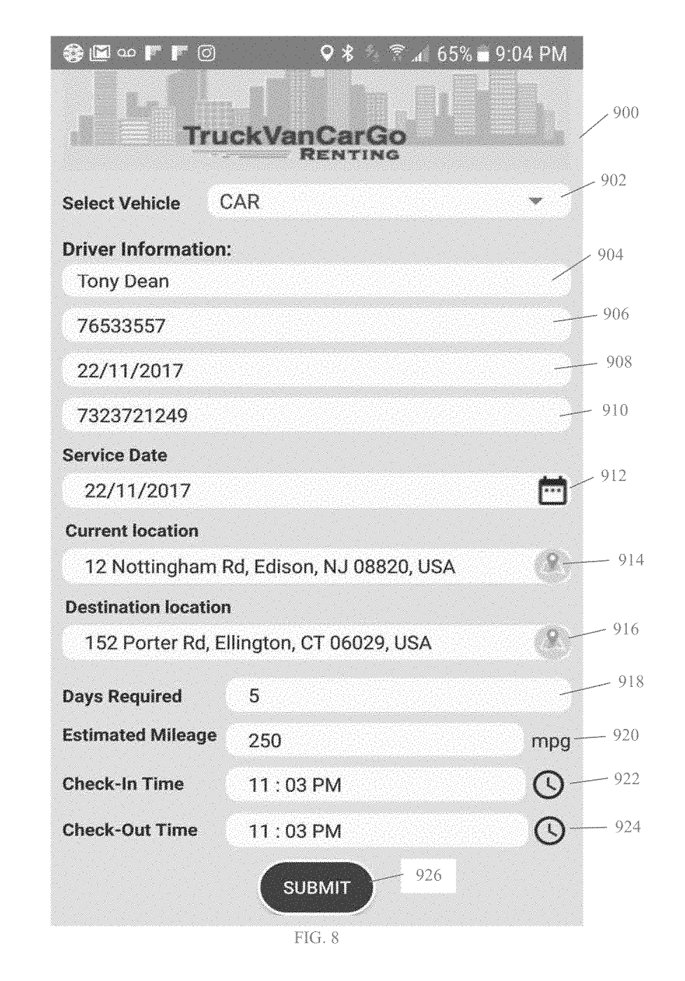

System 400 is one exemplary system for arranging the transportation of people and/or cargo. The ability of a service provider to provide a transportation service requested by a client at a predetermined price is authenticated by the system 400. A transportation arrangement system may incorporate a transportation arrangement system computing device 402 to maintain records of service provider user accounts 414a, 414b, 414c, 414d associated with various service providers who register with the transportation arrangement system as discussed herein with regards to FIG. 5. The system 400 comprises the at least one user computing device 408 adapted for generating transportation service requests 410 for individual user accounts as requested by a respective user, for selecting one or more service providers, and for executing an agreement with the service provider. In some instances, the agreement is directly between the user and service provider. However, alternate embodiments are envisioned, for example, embodiments in which the agreement is between the provider of the transportation arrangement system and the service provider.

The system 400 also includes the at least one service provider computing device 412, utilized by a service provider to interact with the transportation arrangement system computing device and, optionally, the user computing device. Service provider computing device 412 may also generate and communicate service provider data for the individual service provider to transportation arrangement system computing device 402, for storage in a service provider user account 414 associated with the individual service provider. In some embodiments, transportation arrangement system 402 is a server such as server 208, 212 described herein, and the service provider data is saved in a service provider data database such as the database 210, 214 described above. However, the invention is not so limited.

Additionally, service provider computing device 412 may be utilized, for example, for viewing pricing in correlation with available transportation service requests 404, for accepting available transportation service requests 404, and for executing an agreement with a user of the at least one user computing device 408 and/or the provider of the transportation arrangement system that governs the performance of the requested transportation services as described herein.

The system 400 also comprises the at least one transportation arrangement system computing device 402 adapted for receiving the transportation service requests 410 from a user and the transportation service acceptance 404 and the service provider data 406 from the service provider. The at least one transportation arrangement system computing device 402 may utilize data received from the service provider as well as data previously received from the service provider and/or other data entered or received directly by transportation arrangement system computing device from other providers to authenticate the service provider data 406. For example, if a service provider sends service provider data to transportation arrangement system computing device 402 regarding qualifications (e.g., a commercial driver license), transportation arrangement system computing device 402 may be programmed to compare such information to information provided by a third party (e.g., a state motor vehicle department) to confirm that the qualifications provided by the service provider are authentic. Once confirmed, the service provider data 406 maintained at the transportation arrangement system computing device 402 may be updated to indicate that this qualification has been authenticated to, for example, eliminate the need for the service provider to provide the qualifications again at a future date or for easy reference by transportation arrangement system computing device 402 upon re-receipt of such qualifications from the service provider.

The at least one transportation arrangement system computing device 402 is also adapted for executing at least one filtering scheme to create a sub-set of service providers capable of providing each of the transportation service requests 410, determining a price to be charged for the transportation service requests 410, advertising the price for the transportation service requests 410 in correlation with the transportation service request 410 to the respective sub-set of service providers, receiving transportation service acceptances 404 corresponding to available transportation service requests 410 from one or more of the sub-set of service providers, facilitating selection of one of the sub-set of service providers, and facilitating a written agreement governing the performance of the service request. The at least one filtering scheme includes parameters selected from the group consisting of interstate or intrastate transportation service, delivery or vehicle rental services, geographic location in which the transportation service is to be provided, availability information for the service provider, and combinations thereof. For example, in some embodiments of the present invention, a calendar option may be provided for service providers to indicate periods of availability and unavailability to allow system 400 to filter out unavailable service providers when determining the sub-set of service providers to which a service request shall be disseminated.

In a first embodiment of the invention, the transportation arrangement system is programmed to award a transportation service job to the first service provider to respond and/or accept a transportation service request submitted by a requesting user. In another embodiment, if multiple service providers agree to perform the transportation service request at the price calculated by the transportation arrangement system, the system 400 determines the best one of the plurality of accepting service providers based upon various criteria such as, but not limited to, customer rating, quantity of prior requests performed, proximity to the geographic area of the service request, etc. In yet another embodiment of the present invention, if multiple service providers accept a particular service request, the transportation arrangement system 400 allows the user to see all accepting service providers and information pertaining to such service providers to allow the user to select the service provider the user prefers. If no service provider accepts the job, the transportation arrangement system 400 shall be programmed to increase the price to be paid for provision of the service request.

Envisioned is a user application that may execute on the user computing device 408 of the system 400 that will allow users to facilitate the desire to transport people or cargo (i.e., via vehicle rental with or without driving services). This user application may execute on the user computing device 408, which may be a cell phone, personal computer, or the like owned by the user and programmed to execute an application provided by the transportation arrangement system 400. The application may access information available from the transportation arrangement system computing device 402. Registration through this service will be done through one's Google or other online account. It is during the registration process that the customer will provide credit card details to facilitate the payment transactions of services tendered through the customer application executing on the customer's computing device 408. Through this application, the customer will give all the information needed to initiate the service desired, such as, but not limited to, location, description of goods, and the time for transport and arrival. Throughout this process, the application will provide customers with different choices, such as using red or green dots to signify the location of prospective drivers/owners, calculating mileage and rates, and allowing customers a choice in deciding which route or service provider is best from an economic and other perspective.

Also envisioned is a service provider application that will allow drivers/owners to communicate with potential customers/users via transportation arrangement system 400. This service provider application may execute on the service provider computing device 412, which may be a cell phone, personal computer, or the like owned by the service provider and programmed to execute an application provided by the transportation arrangement system 400. Registration through this service will include providing authentic copies of a service provider's information including, but not limited to, the driver's license(s) of service provider personnel vehicle insurance, vehicle registration, bank information, and maximum load carry by vehicle to ensure minimization of risk on the part of the company providing the service. After a user makes a selection as to how he/she wants to ship goods or rent a vehicle, the transportation arrangement system will be notified by the user application so that the transportation arrangement system 400 may determine a price for the requested services and provide the available service request to a sub-set of suitable service providers via communication of information regarding same to the service provider computing devices 412 of each of the sub-set of service providers. If a service provider accepts the service request and associated pricing and the service provider is hired, the service provider application and/or user computing device application is utilized to facilitate the provision of the service request job. For example, the service provider application and/or user application may notify the service provider regarding a location to meet the user/customer to facilitate the service. The application(s) will also provide a way for the service provider to notify the user/customer when the goods have been delivered or details regarding the completion of the rental period, including where to leave the rented vehicle if the customer will be driving the vehicle.

In some embodiments of the invention, the service provider computing device allows service providers to see job and user information including, but not limited to, a full history of customers serviced in the past, user payment information, and the like. Also, the service provider application executed by the service provider computing device may allow the service provider to set up banking or credit card information for a user for easy access to funds. The service provider application may access such desired information about users/customers, wherein some or all of this information is stored at transportation arrangement system computing device 402 or the like in a database or the like. In embodiments, a service provider computing device may create a report detailing payments made and service requests performed on a timed basis, for example, weekly, monthly, annually, etc., which details the work provided and monetary transactions engaged in by the service provider for the respective time period. In some embodiments, service provider computing device(s) 412 and user computing device(s) 408 communicate with transportation arrangement system computing device 402 via the Internet, but the invention is not so limited.

In some embodiments of the present invention, an administrative portal is included that allows users/customers greater control over the services the transportation arrangement system provides. The administrative portal may fully or partially execute on the user computing device 408 with or without communication to transportation arrangement system computing device 402 and its respective data and/or databases. It will allow access to information regarding current service providers such as, but not limited to, the areas in which the service providers operate, rates, prices, vehicles, and reviews of the service providers to get a better understanding of which potential service providers to hire. This portal will also allow users to view past usage of the application and/or to revise personal and billing information for the user. This information may be locally accessible on the user computing device 408 in possession of the user or it may be accessible via network connection from the transportation arrangement system computing device 402 or from other online sources.

Also envisioned is a customer relationship management (“CRM”) portal that allows users and service providers an easy and efficient way to interact with the provider of the transportation arrangement system and its associated computer application. In some embodiments, this CRM portal will process all of the payments between the transportation arrangement system and the users and service providers. This portal may also optionally include information and intake screens that allow the user and service provider to setup and maintain user and service provider accounts, respectively, as well as support pages that allow users and service providers to seek answers for issues or questions, including requesting new features for the application/system and/or resolving problems with service, payment, or the like. Furthermore, embodiments are envisioned in which can view support forums, ask questions, rate customers and drivers/owners they have done business with and view personal and billing information to have a better experience with the service and revise or update important information.

The CRM application will be accessible via a computing device that is stationary (e.g., a personal computer) or mobile (e.g., a cell phone) without departing from the scope hereof. The CRM portal and the CRM application described above may be fully or partially resident on the transportation arrangement system computing device 402. Service providers using the service provider computing device 412 and customers using the user computing device 408 may access the CRM portal, the CRM application and other services provided at least partially by the transportation arrangement system computing device 402

With regards to the user application executing at least partially on the client user computing device 408, when it is launched, it may pull the location of the user computing device 408 executing the application. For embodiments of the invention in which cargo is to be transported, upon entering the delivery stop locations for the cargo (e.g., the pickup location and delivery location), multiple red dots will appear in the application, optionally overlaid atop a geographical map, to signify the service providers available to fulfil the requested service request(s). After the user chooses the service provider, the user application, alone or in concert with an application operating on the transportation arrangement system computing device 402, will then calculate the price to be charged to the user for the service request. This price may include factors such as, but not limited to, mileage, tolls, rate per mile based on a fair market value of the diesel or gasoline price for the requested date of service, rate for total mileage, rate for the weight of the goods to be transported, rate for the dimensions of the goods to be transported, rate per day, rate per delivery stop. In some embodiments of the present invention, the transportation arrangement system computing device application selects one or more service providers to perform the service request at the most affordable price. In other embodiments, customers may select one of a plurality of service providers offering the most affordable price. After the user makes a final service provider selection, and the selection is optionally accepted by the service provider, the user may provide his/her credit card information, online payment account information, or the like in order to finalize a contract if this information has not been previously provided. After the transportation arrangement system computing device application confirms and processes the user's payment, the service provider is then authorized to provide the service requested (e.g., the service provider might go to the customer's location with his/her vehicle to pick up the goods to be transported or to deliver the vehicle that has been rented, etc.). The transportation arrangement system computing device application, with or without human approval, will be responsible for paying the service providers for the services provided through the application. The user will be informed by the service provider when the service request has been completed, and the receiver of the goods (when applicable) will also have the ability to inform the user of the goods' arrival via a user account. This information will be supplied to the users via real-time alerts and notifications through the application on the user computing device such as user computing device 408. In some embodiments of the invention, if any portion (e.g., the estimated days or miles required for performance of the service request) of the estimated cost is reasonably exceeded by the service provider, the user will be automatically charged for the excess charges upon completion of the service.

In some embodiments of the invention, the provider of the transportation arrangement system may also operate as a service provider or may employ service providers without departing from the scope hereof. Such service provider may operate the transportation arrangement system computing device 402 as described herein including collecting payment from users and distributing funds for services they have performed for users.

In one embodiment of the invention for renting a vehicle, the process is as follows:

1. The user chooses an option for intrastate/interstate service.

2. The user chooses a type of vehicle (e.g., truck, van, etc.) to be rented.

3. The user provides starting date of service, start and end locations, and how many days the user plans to rent the vehicle. The user may also enter at this point or elsewhere whether the user requests services of a driver or if the user will supply the driver.

4. Upon entering the various service request parameters (e.g., date of service, whether the customer wants to rent a truck or van, the start and end locations, and the number of days the customer wishes to rent the truck or van), multiple green dots will appear regarding individual service providers who will allow rental of a vehicle matching the specified service request parameters entered by the user.

5. Upon choosing a specific service provider, the application will calculate the price to be paid by the user for the rental. The price may include, without limitation, mileage, any tolls needing to be covered, rate per mile based upon the fair market value of the diesel or gas price for the requested date of service, total cost for mileage, rate per day, total cost for rental days, cost of insurance, cost of gas, etc.

6. The user may view various service providers in conjunction with the price to be charged to allow the user to select the service provider with the lowest price.

7. Upon the user selecting a service provider, a contract will begin whereby the user will provide payment information, if this information was not previously provided, and upon confirmation of payment to the provider of the transportation arrangement system, the service provider will initiate the service requested by the user. For example, the vehicle for rent will be made available for pickup, or delivered to, the user.

8. If the service request is successfully performed, a notification will be sent to the user and the user's credit card will be charged by the provider of the transportation arrangement system. If the service request is not successfully performed (e.g., the wrong goods are delivered), the service provider will be required to obtain and deliver the appropriate goods at its own expense. Only after successful performance of the service request/job will the customer's payment information be charged to the provider of the transportation arrangement system. In an embodiment, there may be a limit to the number of allowed attempts to complete the service request (e.g., redelivery attempts).

9. The provider of the transportation arrangement system will be responsible for paying the drivers of the vehicles in instances in which the user will not be supplying the driver.

10. The user will be informed by the service provider providing the rented vehicle as to where to leave the vehicle upon completion of the rental in cases in which the user has provided the driver.

11. Any additional costs not anticipated in the original price (e.g., miles or days users utilize the vehicle in excess of the information entered by the user prior to the rental) will automatically be charged to the user when the vehicle is returned.

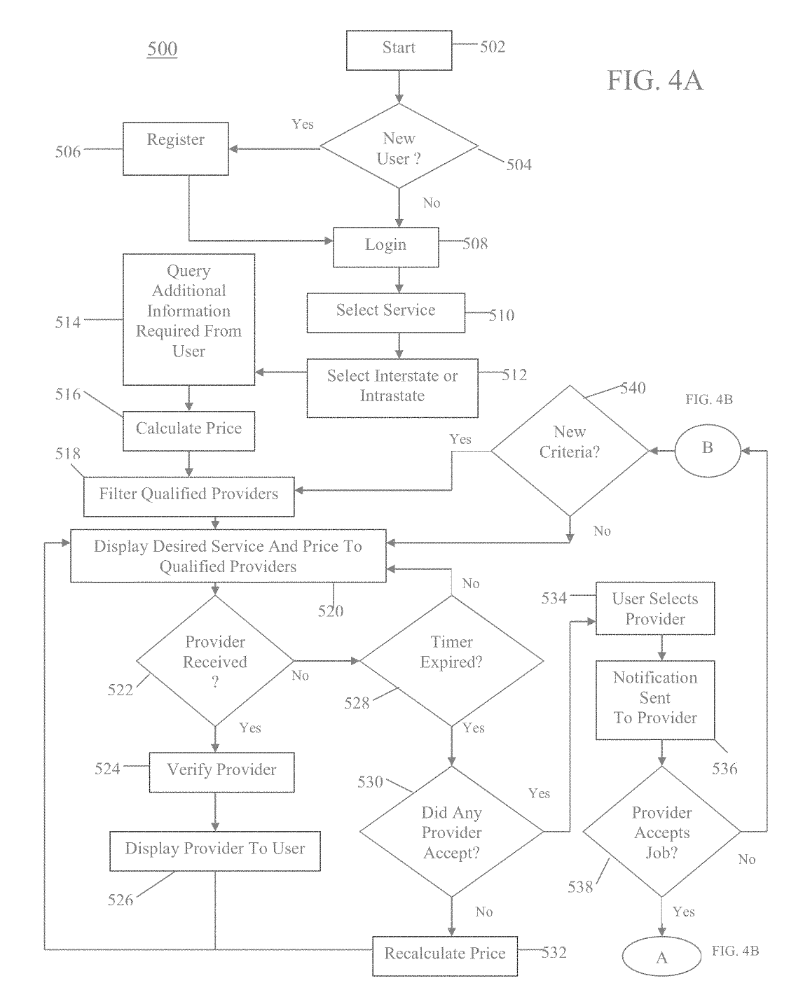

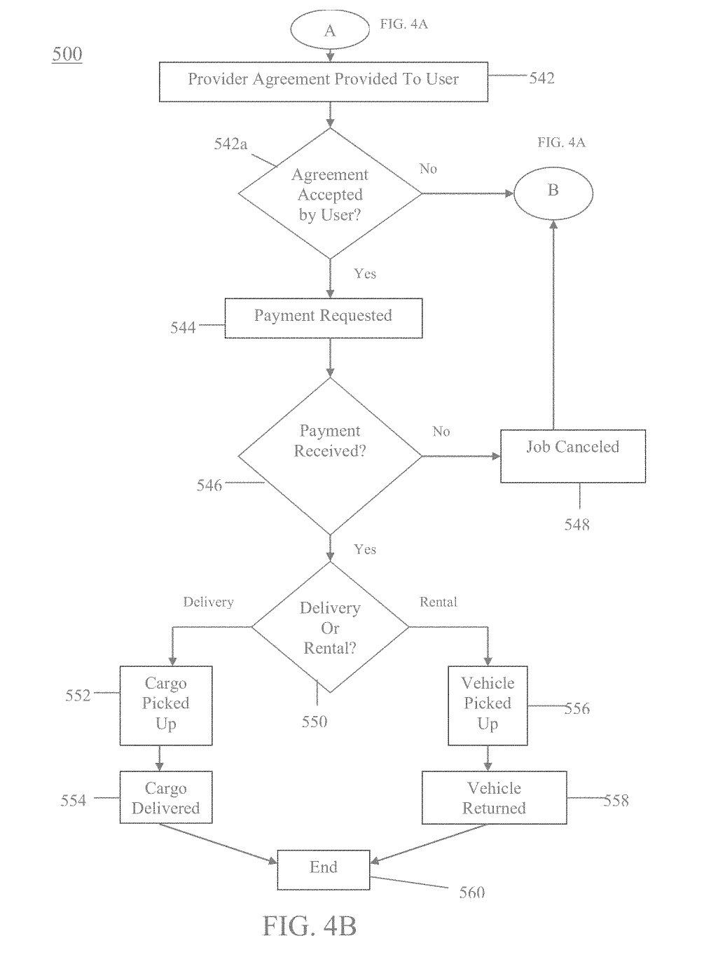

FIGS. 4A and 4B are flowcharts of a method 500 for arranging transportation for people and/or cargo in accordance with an embodiment of the present disclosure. The interactions of the method 500 may be carried out by the components of the system 400 described above and depicted in FIG. 3.

The method 500 starts at block 502 and proceeds to decision point 504 at which it is determined if the user is new. The user may be the customer and a user of the client user computing device 408. If the user is new, the user registers at block 506 and logs in at block 508. If the user is not new, the user logs in at block 508.

Proceeding to block 510, the user selects a service to be provided to the user. In the depicted embodiment, the services available are domestic, international, express shipping, and vehicle rental, however, alternate embodiments may include only one of these services or varying services without departing from the scope hereof. Next, at block 512, if the user selected domestic shipping, express delivery, or vehicle rental, the user selects interstate or intrastate services. At block 514, additional required information is queried from the user regarding the services to be provided including, but not limited to, location, description of goods and/or people, quantity of goods and/or people, and the time for transport and arrival. In some embodiments of the invention, exemplary input screen 700 is utilized to obtain the following information from a user who wishes to transport people and/or cargo: date service request begins 702, location of the people and/or cargo 704, destination location for the people and/or cargo 706, quantity of people and/or cargo being transported 708, numerical weight of the goods 710, unit of measurement for the weight of the goods 712, and a description of the goods 714. After the user enters this data, the user submits it to the transportation arrangement system by clicking on 716.

In some embodiments of the invention, exemplary display screen 900 is utilized to obtain the following information from a user who wishes to rent a vehicle: type of vehicle 902; driver name 904; driver number 906; date of service of driver 908; driver telephone number 910; date service request begins 912; start location of the rental 914; destination location for the rental 916; days of use of the rental 918; estimated mileage 920; check-in time 922; and check out time 924. After the user provides this data, the user submits it by clicking submit at 926.

+ Next, at block 516, a price to be charged for the service request is calculated. In some embodiments of the present invention, a flat rate is charged when the goods and/or people are travelling less than a predetermined distance. For example, if the user chose express delivery and the distance is less than a predetermined distance, a flat fee may be charged. When goods and/or people are travelling beyond the predetermined flat rate distance, the pricing formula may change to a charge per mile. Or, in some embodiments, excess mileage charges may be added to a base flat rate cost.

Additional charges may also be added for specific scenarios such as use of diesel fuel, tolls and other expenses, weight of the goods, driver or other insurance, pickup lift gate or drop lift gate, curb-side delivery or inside delivery, and the like. Tolls and other expenses may be estimated costs, actual costs, or a miscellaneous percentage charge.

In addition, in embodiments in which a driver is transporting the people and/or cargo, the driver's wages are also included in the price to be charged to the user. In some embodiments, the amount to be included is an hourly cost multiplied by anticipated hours of travel. Or, alternatively, this amount may be a flat daily rate multiplied by the anticipated days of travel. In some embodiments, customers may be given volume discounts for shipping goods.

In the depicted embodiment, a service provider fee to be paid to the service provider (e.g., the owner of the vehicle to be utilized) and a system provider fee to be paid to the provider of the transportation arrangement system shall also be included in the price to be charged to the user. These fees may be flat, percentage, or any other formula for calculating fees without departing from the scope hereof.

In one example embodiment, a customer wishing to ship cargo less than seventy (70) miles will be charged a flat rate based upon the number of pallets being shipped (e.g., $250.00 for one pallet, $400.00 for two pallets, $450.00 for three pallets, etc.). If the distance is to exceed seventy (70) miles, the price will be a flat rate plus a cost per mile.

Use of special fuels such as diesel or the like may be added to the price at a specific cost per mile. Further, if a driver is provided, the cost may be added to the price as a rate per hour. Or, in some embodiments, if a driver drives more than a predetermined number of hours (e.g., three), then the driver would be paid a daily rate in lieu of hourly. Tolls and other expenses may be actual fees, or a percentage surcharge added to the calculated price. Additionally, a percentage mark-up (e.g., 55%) or a fixed fee may be added to compensate the owner of the vehicle for use of the vehicle. Additional fees may also be added to accommodate for the weight of the cargo being transported on a per pound basis (or other measurement basis). And, an additional commission fee (e.g., 15%) may be charged to be paid to the owner of the transportation arrangement system. Additional costs may apply. Insurance may cost a fixed price per day (e.g., $10 per day) for rental or cargo delivery. Pickup lift gate or drop lift gate may cost an additional flat fee (e.g., $55.00). Pickup inside and inside delivery may also be a flat fee (e.g., $80.00 each). The above example is merely illustrative and other methods of calculating a price may be substituted without departing from the scope hereof.

At block 518, qualified providers are filtered to create a sub-set of service providers to whom the service request will be advertised/disseminated. At block 520, the service request and associated price are displayed to the sub-set of qualified service providers as determined by the transportation arrangement system such as system 400. In some embodiments of the invention, exemplary display screen 800 is utilized to display the following information to the service provider: user mobile telephone number 802; user email address 804; date service request begins 806; start location of the people and/or cargo 810; destination location for the people and/or cargo 812; days of use of the vehicle 814; estimated fuel required 816; check-in time 820; check out time 822; driver name 824; driver telephone number 826; and driver license number 828. After the service provider views this data, the service provider continues to the next screen by clicking on 830 or cancels by clicking 832. In the depicted embodiment, the price may be displayed to the service provider on the next screen.

The method 500 then proceeds to decision point 522, at which it is determined if a new service provider has been received to perform the service request (i.e., a new service provider accepted the service request for the price calculated at 516). If yes, the service provider is verified at block 524, and the service provider is displayed to the user at block 526. The method 500 then returns to block 520 and repeats.

Returning to decision point 522, if a new service provider has not accepted the service provider request, the method 500 proceeds to decision point 528 at which it is determined if a timer has expired. In the depicted embodiment, the timer is set for one day. That is, the sub-set of service providers has one day to accept or reject the service request. However, alternate time periods may be substituted without departing from the scope hereof. Also, embodiments are envisioned in which the time expires upon the verification of the first service provider to accept the service request. However, the invention is not so limited.

If, at 528, the timer has not expired, the method 500 returns to block 520 at which the desired service and corresponding price continue to be displayed to the sub-set of service providers capable of handling the project. If at decision point 528 it is determined that the timer has expired, the method 500 proceeds to decision point 530 at which it is determined if any service provider accepted the service request at the calculated price. If no, the method 500 proceeds to block 532 at which the price is recalculated to increase same. The method 500 then proceeds to block 520 at which it operates as described above.

If at decision point 530 it is determined that a service provider has accepted the service request and corresponding price, the method 500 proceeds to block 534 at which the user selects (i.e., agrees to use) the service provider to perform the desired service request. Next, at block 536, notification is sent to the service provider that the offer to perform the service request has been accepted. The method 500 then proceeds to decision point 538 at which it is determined if the provider accepts the job by confirming same. If no, the method 500 proceeds to decision point 540 at which the user is provided with an opportunity to modify the criteria associated with the service request. If new criteria are entered by a user, method 500 proceeds to block 518 at which qualified providers are again filtered based upon the new criteria. If new criteria are not entered, the method 500 proceeds to block 520 at which as described above, the desired service request and price are displayed to qualified providers.

Returning to decision point 538 at which it is determined if the service provider accepts the job, if yes, in the depicted embodiment, the transportation arrangement system generates an agreement to govern the terms of performance of the service request and such agreement is sent to the requesting user. However alternate embodiments are envisioned including, but not limited to, ones in which the service provider provides the agreement directly to the user or vice versa. Then, the method 500 proceeds to decision point 542 (FIG. 4B) at which it is determined if the agreement has been accepted by the user. If not, the method 500 proceeds to 540 (FIG. 4A) and proceeds as described above. If, at decision point 542, if it is determined that the agreement has been accepted by the user, the method 500 proceeds to block 544 at which payment is requested. Payment may be made via any form known in the art without departing from the scope hereof.

Thereafter, at decision point 546 it is determined if payment has been received. If not, the method proceeds to block 548 at which the job is cancelled. The method 500 then proceeds to decision point 540 (FIG. 4A) at which method 500 proceeds as described above. Alternatively, if at decision point 546, if it is determined that payment has been received, method 500 proceeds to decision point 550 at which it is determined whether the arrangements involve delivery or rental. If delivery, the method 500 proceeds to block 552 at which cargo and/or people are picked up and thereafter to block 554 at which cargo is delivered. The method 500 then ends at 560.

If at decision point 550 it is determined that the arrangements involve rental, the method 500 proceeds to block 556 at which the vehicle is picked up by the user and subsequently to block 558 at which the vehicle is returned by the user to the service provider. The method 500 then ends at 560.

Referring now to FIGS. 5A and 5B, depicted are flowcharts of a method for a driver to arrange transportation for people and/or cargo in accordance with an embodiment of the present disclosure. A method 600 is provided that begins at block 602. At decision point 604 it is determined if the service provider is new or not new (i.e., whether the service provider has previously registered with the transportation arrangement system such as system 400). If new, the provider registers at block 606. Registration includes, for example, populating a new user template with information such as, but not limited to, name, address, email address, age, user ID, password, etc. After registration, the service provider may log in at block 608. If not new, the service provider proceeds directly to block 608 and logs in.

Next, the method 600 proceeds to decision point 610 at which it is determined if the provider is a master or sub-driver. If a master driver, the method 600 moves to several menu items for the user. At block 622, the master driver service provider may select to view any new service requests. These service requests may be, for example, service requests entered by a user for which a transportation arrangement system such as system 400 determined that this master driver should be included in the sub-set of acceptable service providers capable of performing the service request. Upon execution of this option, block 624 is performed at which the service provider can view the details of the service request and the associated price to be paid for performance of the work. Also, at block 624 the service request is accepted or rejected by the service provider. Method 600 then returns to block 622 at which the service provider has the option to select a new service request, if any.

At decision point 626, the master service provider may select to view any new jobs for which the service provider agreed to perform it for the stated price and the user subsequently chose the service provider to perform the selected task. Upon execution of this option, block 628 is performed at which the service provider can view the details of the job. Also, at block 628 the job is accepted or rejected by the service provider and the service provider can provide an agreement to govern performance of the job. Method 600 then returns to block 626 at which the service provider has the option to select a new job, if any.

At decision point 630, the master service provider may select to add a sub-driver. A sub-driver is a person other than the master service provider who is authorized by the master service provider to transport people and/or cargo. Upon execution of this option, block 632 is performed at which the service provider can enter information regarding the sub-driver being added including, but not limited to, name, address, driver license no., etc. Once the entered data is saved, method 600 then returns to block 630 at which the service provider has the option to enter another sub-driver, if any.

At decision point 634, the master service provider may select to add a vehicle. The vehicle is a vehicle such as a truck, van, car, or the like that may be rented or may be purchased with a driver to transport people and/or cargo. Upon execution of this option, block 636 is performed at which the service provider can enter information regarding the vehicle being added including, but not limited to, manufacturer, model number, license plate number, etc. Once the entered data is saved, method 600 proceeds to block 638.

At 638, the entered vehicle may be assigned as available for rental only, delivery only, or rental and delivery. This allows the transportation arrangement system to determine whether a service provider associated with the vehicle may be included in a sub-set of providers who can perform a service request. Finally, at 640, all drivers authorized to drive the vehicle are assigned to the entered vehicle. These drivers are registered with the system at step 606 or steps 630 and 632. Thereafter, the vehicle is added. If a user wishes to enter a new vehicle, the user again executes process 634 and the process repeats.

At decision point 642, the master service provider may view a list of payments received from users and/or from the transportation arrangement system on behalf of a user (i.e., payment for a job that was performed or is to be performed). If a payment has not been received for a scheduled job, the service provider may elect to cancel the job at which process 600 proceeds to 644, at which the job is cancelled. Alternatively, if a payment is received for a particular job, process 600 proceeds to 646, at which the job is scheduled. Next, at 648 the job is performed by the master driver or a designated sub-driver. Thereafter the process ends at block 650.

If at 610, the user is a sub-driver, the method 600 proceeds to decision point 612, at which any new jobs are displayed to a user. That is, in the depicted embodiment, during acceptance of a job by a master driver at 626, the master driver may assign a sub-driver to the project. Upon such an assignment, the job becomes available in the sub-driver's new job list.

At 614, the new job may be accepted or denied by the sub-driver. If not accepted, the job is denied at block 616 and the method 600 proceeds back to decision point 612 at which it is determined if another new job is available. Simultaneously, the new job is added back to the master driver list to allow the master driver to perform the job himself or herself, or to select a new sub-driver for the job. Alternatively, if the job is accepted at decision point 614, the job is performed at block 618 and payment is received at block 620. That is, at 620, the payment is received by the sub-driver from the master driver who hired the sub-driver to perform the job. Thereafter, moving to FIG. 5B, block 650 is performed at which the job ends. At this point, the completed job may be added to the master driver and sub-driver's list of completed projects.

at decision point 642 it is determined if payment has been received. If not, the job is cancelled at block 644. If yes, service is scheduled at block 646, service is performed at block 648 and the method ends at block 650.

Although several processes have been disclosed herein as software, it may be appreciated by one of skill in the art that the same processes, functions, etc. may be performed via hardware or a combination of hardware and software. Similarly, although the present invention has been depicted as a hardwired system, these concepts may be applied to wireless systems and hybrid hardwired and wireless systems without departing from the scope of the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A transportation arrangement system for transporting a person or cargo by authenticating a service provider's ability to provide the transportation service at a predetermined price, the transportation arrangement system comprising:
at least one client user computing device adapted for generating transportation service requests for individual user accounts as requested by a respective user; for selecting the service provider; and for executing an agreement with the service provider;
at least one client service provider computing device generating service provider data for individual service provider user accounts associated with a respective service provider; for viewing pricing in correlation with available transportation service requests; for accepting available transportation service requests; and for executing an agreement with the user; and
at least one transportation arrangement system computing device adapted for:
receiving the transportation service requests and the service provider data;
authenticating the service provider data; executing at least one filtering scheme to create a sub-set of service providers capable of providing each of the transportation service requests; determining a price to be charged for the transportation service requests; advertising the price for the transportation service requests in correlation with the transportation service request to the respective sub-set of service providers; receiving acceptance of available transportation service requests from one or more of the sub-set of service providers; facilitating selection of one of the sub-set of service providers;
facilitating a written agreement between the user and the selected one of the sub-set of service providers.

2. The system of claim 1, wherein the at least one filtering scheme comprises parameters comprising at least one of interstate and intrastate transportation services, delivery and vehicle rental services, geographic location in which the transportation services are to be provided, a calendar option for blocking out locations of drivers in correlation to dates, and availability information for the service provider.

3. The system of claim 1, wherein transportation services include services of a driver.

4. The system of claim 1, wherein a customer relationship management portal is provided allowing users and service providers to interact with the transportation arrangement system computing device.

5. The system of claim 1, wherein an administrative portal executes on the at least one client user computing device and accesses a database of current driver/owners.

6. The system of claim 5, wherein the administrative portal further provides information regarding at least one of rates, prices, vehicles, and reviews of driver/owners.

7. The system of claim 1, wherein a driver/owner portal executes on the at least one client service provider computing device and enables driver/owners to access histories of customers and access payment information.

8. The system of claim 1, wherein an application executing on the at least one transportation arrangement system computing device and accessible by the at least one client user computing device and accessible by the at least one client service provider computing device facilitates vehicle rental operations.

9. A transportation service method for transporting a person or cargo by authenticating a service provider's ability to provide the transportation service at a predetermined price, the transportation service method comprising:
at least one user computing device generating a transportation service request, the transportation service request communicated to a transportation arrangement system computing device;
the transportation arrangement system computing device selecting a service provider to perform the service request;
the at least one transportation arrangement system computing device authenticating the service provider data;
the transportation arrangement system computing device generating an agreement with the service provider to govern performance of the service request;
at least one service provider computing device generating service provider data for the selected service provider,
the at least one service provider computing device accepting the transportation service request as per the direction of a service provider;
the at least one service provider computing device executing the agreement as per the direction of the service provider;

10. The method of claim 9, further comprising the at least one transportation arrangement system computing device executing at least one filtering scheme to create sub-sets of service providers capable of providing transportation service requests.

11. The method of claim 10, further comprising the at least one transportation arrangement system computing device determining prices to be charged for the transportation service requests.

12. The method of claim 10, further comprising the at least one transportation arrangement system computing device advertising prices for the transportation service requests to the sub-set of service providers.

13. The method of claim 9, further comprising users of the at least one client user computing device registering for accessing transportation services by creating an online account and furnishing credit card information.

14. The method of claim 9, wherein the least one filtering scheme comprises parameters comprising at least one of interstate and intrastate transportation services, and delivery and vehicle rental services.

15. The method of claim 9, wherein the least one filtering scheme comprises geographic location in which the transportation services are to be provided, a calendar option for blocking out locations of drivers in correlation to dates, and availability information for the service provider.

16. The method of claim 9, further comprising the at least one client user computing device specifying start and end locations, weight and dimensions of goods to be transported, and number and locations of delivery stops in generating the transportation service request;

17. A transportation arrangement system for transporting a person or cargo, comprising:
a processor;
a memory;
an application stored in the memory that when executed on the processor:
receives transportation service requests and service provider data for candidate service providers to service the requests;
authenticates the service provider data;
executes at least one filtering scheme to create a sub-set of service providers capable of providing each of the transportation service requests;
determines prices to be charged for the transportation service requests; and
receives acceptance of the transportation service requests from at least one of the sub-set of service providers.

18. The method of claim 17, wherein the application further facilitates a written agreement between a user of at least one client user computing device and the selected one of the sub-set of service providers.

19. The method of claim 17, further comprising the application providing a customer relationship management (CRM) portal processing payments between users of the at least one client user computing device and service providers.

20. The method of claim 17, wherein the at least one filtering scheme comprises parameters comprising at least one of interstate and intrastate transportation services, delivery and vehicle rental services, geographic location in which the transportation services are to be provided, a calendar option for blocking out locations of drivers in correlation to dates, and availability information for service providers.
